(19) United States
(12) Patent Application Publication
(10) Pub. No.: US 2021/0213685 A1
(43) Pub. Date: Jul. 15, 2021

(54) METHOD FOR THREE-DIMENSIONAL PRINTING

(71) Applicants: XYZprinting, Inc., New Taipei City (TW); Kinpo Electronics, Inc., New Taipei City (TW)

(72) Inventor: Yu-Jie Yang, New Taipei City (TW)

(73) Assignees: XYZprinting, Inc., New Taipei City (TW); Kinpo Electronics, Inc., New Taipei City (TW)

(21) Appl. No.: 16/820,743

(22) Filed: Mar. 17, 2020

(30) Foreign Application Priority Data
Jan. 14, 2020 (CN) 202010035989.5

(51) Int. Cl. B29C 64/393; B33Y 50/02; B33Y 30/00; B29C 64/25

(52) U.S. Cl. CPC B29C 64/393; B29C 64/25; B33Y 30/00; B33Y 50/02

(57) ABSTRACT

A method for three-dimensional printing is provided. The method includes: determining whether a first bracket is going to collide with a second bracket when a first control command corresponding to a first print head among a plurality of control commands and a second control command corresponding to a second print head among the plurality of control commands are executed simultaneously. If yes, execution of the first control command is suspended to stop a printing operation performed by the first print head, and the second control command is executed so that the second print head performs the printing operation according to the second control command.

### CROSS-REFERENCE TO RELATED APPLICATION

This application claims the priority benefit of China application no. 202010035989.5, filed on Jan. 14, 2020. The entirety of the above-mentioned patent application is hereby incorporated by reference herein and made a part of this specification.

### TECHNICAL FIELD

The invention relates to an apparatus and a method for three-dimensional printing, and more particularly, to an apparatus and a method applied to multi print heads.

### BACKGROUND

With the advancement of science and technology, three-dimensional printing technology is becoming more and more mature. Furthermore, the three-dimensional printing technology can quickly materialize a digital 3D model by superimposing. Compared with traditional subtractive processing, three-dimensional printing technology has a competitive advantage in having the capability of simplifying production process and improving production efficiency as well as reducing waste on materials and costs.

U.S. Pat. No. 9,623,607 proposes a three-dimensional printing device having a plurality of print heads. However, how to avoid mutual interference during the process of printing with multiple print heads at the same time is one of the problems to be solved by those skilled in the art.

### SUMMARY

The invention provides an apparatus and a method for the three-dimensional printing that can allow the three-dimensional printing apparatus having multiple print heads to prevent the print heads from collision during the printing process and effectively improve a printing efficiency for the print heads.

The invention proposes a three-dimensional printing apparatus, which includes a first print head, a second print head and a processor. The first print head is slidably disposed on a first bracket so that the first print head moves along a first axis direction. The first bracket is slidably disposed on a first guiding bracket so that the first bracket moves along a second axis direction. The second print head is slidably disposed on a second bracket so that the second print head moves along the first axis direction. The second bracket is slidably disposed on a second guiding bracket so that the second bracket moves along the second axis direction. The processor is configured to execute a plurality of control commands to control the first print head and the second print head to move and perform a printing operation. In the operation of performing the printing operation, the processor determines whether the first bracket is going to collide with the second bracket when a first control command corresponding to the first print head among the plurality of control commands and a second control command corresponding to the second print head among the plurality of control commands are executed simultaneously. When the first bracket is going to collide with the second bracket, the processor suspends execution of the first control command to stop the printing operation performed by the first print head, and executes the second control command so that the second print head performs the printing operation according to the second control command.

The invention proposes a method for three-dimensional printing adapted to a three-dimensional printing apparatus, and the apparatus includes a first print head, a second print head and a processor. The first print head is slidably disposed on a first bracket so that the first print head moves along a first axis direction. The first bracket is slidably disposed on a first guiding bracket so that the first bracket moves along a second axis direction. The second print head is slidably disposed on a second bracket so that the second print head moves along the first axis direction. The second bracket is slidably disposed on a second guiding bracket so that the second bracket moves along the second axis direction. The processor is configured to execute a plurality of control commands to control the first print head and the second print head to move and perform a printing operation. In the operation of performing the printing operation, the method includes: determining whether the first bracket is going to collide with the second bracket when a first control command corresponding to the first print head among the plurality of control commands and a second control command corresponding to the second print head among the plurality of control commands are executed simultaneously; when the first bracket is going to collide with the second bracket, suspending execution of the first control command to stop the printing operation performed by the first print head, and executing the second control command so that the second print head performs the printing operation according to the second control command.

Based on the above, the apparatus and the method for the three-dimensional printing can allow the three-dimensional printing apparatus having multiple print heads to prevent the print heads from collision during the process and effectively improve the printing efficiency for the print heads.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a top view of an apparatus for three-dimensional printing in an embodiment of the invention.

FIG. 2 is a flowchart of a method for three-dimensional printing in an embodiment of the invention.

FIG. 3A to FIG. 3C are schematic diagrams illustrating moving areas of the first print head and the second print head in an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

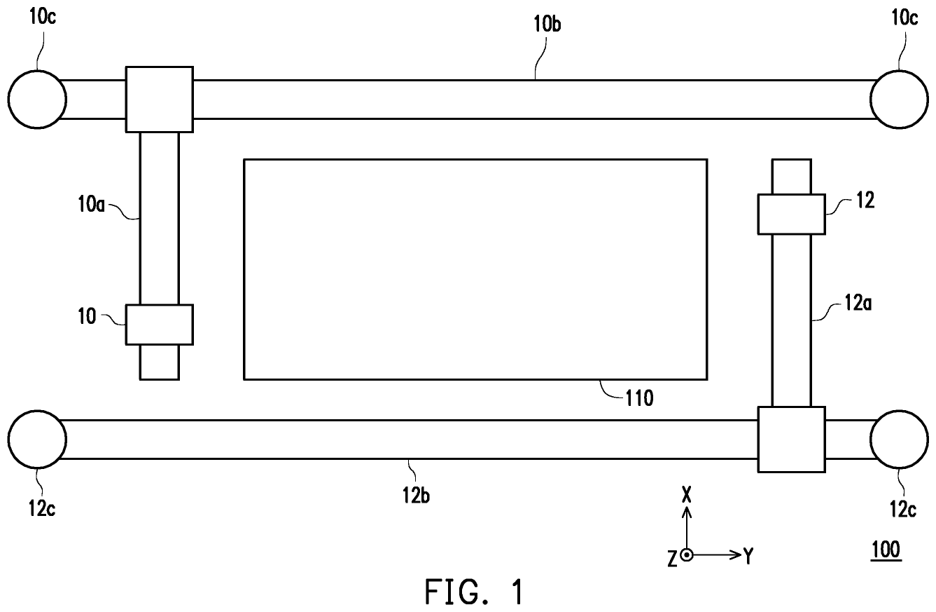

FIG. 1 is a top view of an apparatus for three-dimensional printing in an embodiment of the invention.

Referring to FIG. 1, in this embodiment, a three-dimensional printing apparatus 100 adopts a fused deposition modeling method to materialize a digital three-dimensional model, that is, to print the three-dimensional object (not illustrated) according to digital three-dimensional model information. For example, a processor of the three-dimensional printing apparatus 100 converts the digital three-dimensional model information into sliced objects on multiple layers, and prints the sliced objects one layer at a time to generate the materialized three-dimensional model described above.

The three-dimensional printing apparatus 100 includes a printing platform 110, a first print head 10, a first bracket 10a, a first guiding bracket 10b, a third guiding bracket 10c, a second print head 12, a second bracket 12a, a second guiding bracket 12b and a fourth guiding bracket 12c.

The platform 110 is disposed on a base (not illustrated), and configured to bear fused filaments output by the first print head 10 and the second print head 12. Further, the platform 110 is, for example, stationary or has a degree of freedom for moving along at least one direction (e.g., a direction Z) in space. In this embodiment, the platform 110 may provide a printing area required by the first print head 10 and the second print head 12. For example, a size of the printing area may be equal to or less than a size of the platform 110. The following description is made by taking the size of the printing area equal to the size of the platform 110 as an example.

The first print head 10 is slidably disposed on the first bracket 10a and may move relative to the printing platform 110 along a direction X (a.k.a. a first axis direction) through the first bracket 10a. Further, the first bracket 10a is slidably disposed on the first guiding bracket 10b so that the first bracket 10a moves relative to the printing platform 110 along a direction Y (a.k.a. a second axis direction). The first guiding bracket 10b is slidably disposed on the third guiding bracket 10c so that the first guiding bracket 10b may move relative to the printing platform 110 along the direction Z (a.k.a. a third axis direction) through the third guiding bracket 10c.

The second print head 12 is slidably disposed on the first bracket 12a and may move relative to the printing platform 110 along the direction X through the second bracket 12a. Further, the second bracket 12a is slidably disposed on the second guiding bracket 12b so that the second bracket 12a moves relative to the printing platform 110 along the direction Y. The second guiding bracket 12b is slidably disposed on the fourth guiding bracket 12c so that the second guiding bracket 12b may move relative to the printing platform 110 along the direction Z through the fourth guiding bracket 12c.

It should be noted that, a three-dimensional moving mechanism of the three-dimensional printing apparatus is not particularly limited by the invention. Other three-dimensional moving mechanisms may be adopted according to actual design requirements so that the first print head 10 and the second print head 12 may move relative to the platform along three directions in space.

In addition, the three-dimensional printing apparatus 100 further includes a processor (not illustrated). The processor is configured to control elements (e.g., motors) in the three-dimensional moving mechanism in the three-dimensional printing apparatus 100 to allow the first print head 10 and the second print head 12 to move relative to the platform along three directions in space through the three-dimensional moving mechanism illustrated in FIG. 1. Here, the processor is further configured to provide control commands to the first print head 10 and the second print head 12 to make the first print head 10 and the second print head 12 discharge materials to the printing platform 110 for performing a three-dimensional printing operation. It should be noted that, in an embodiment, the first print head 10a and the second print head 12a are configured to print different parts of a same object. However, in other embodiments, the first print head 10a and the second print head 12a are configured to print two different (or independent) objects, respectively.

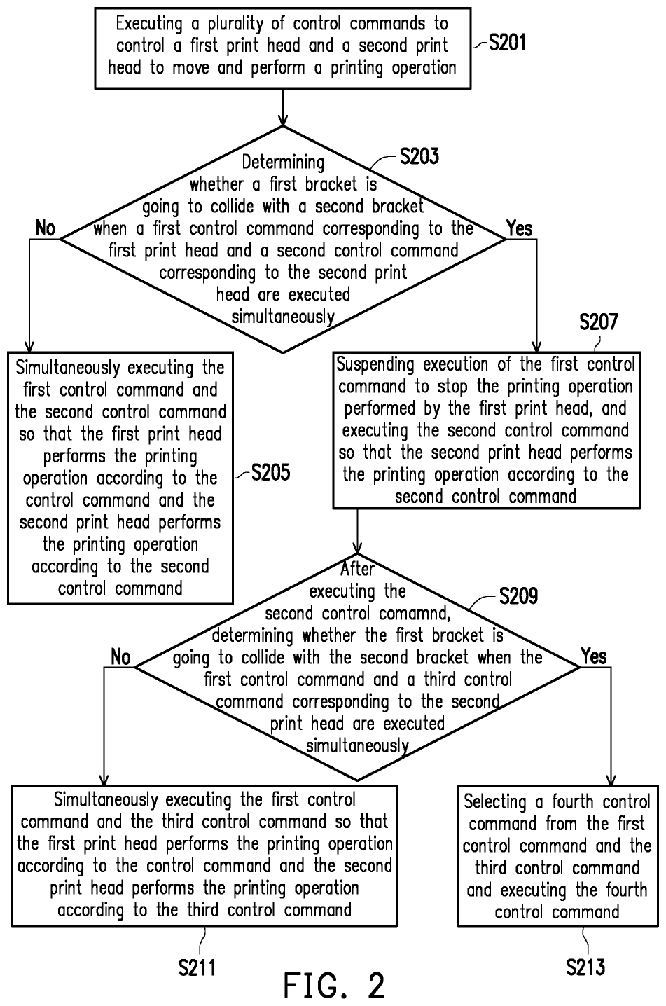

FIG. 2 is a flowchart of a method for three-dimensional printing in an embodiment of the invention.

Referring to FIG. 1 and FIG. 2, first of all, when the three-dimensional printing apparatus 100 intends to print a three-dimensional object according to the three-dimensional model information, the processor of the three-dimensional printing apparatus 100 may obtain a plurality of control commands corresponding to printing of the three-dimensional object. These control commands are, for example, G codes. The processor may execute the control commands described above to control the first print head 10 and the second print head 12 to move and perform a printing operation (step S201). For example, the processor may, for example, classify the control commands into first-type control commands for controlling the first print head 10 and second-type control commands for controlling the second print head 12. Next, the processor may select a control command to be provided to the first print head 10 (hereinafter, referred to as a first control command) from the first-type control commands, and select a control command to be provided to the second print head 12 (hereinafter, referred to as a first control command) from the second-type control commands.

Then, the processor determines whether the first bracket 10a is going to collide with the second bracket 12a when the first control command corresponding to the first print head 10 and the second control command corresponding to the second print head 12 are executed simultaneously (step S203). In other words, the processor determines whether the first bracket 10a and the second bracket 12a are staggered when the first control command and the second control command are executed simultaneously.

For instance, the processor determines whether the first bracket 10a is going to collide with the second bracket 12a within a future time interval (e.g., 10 seconds) according to location information (e.g., coordinates) in the first control command and the second control command. With the first print head 10 as an example, the processor may learn a current location of the first print head 10 and a location to be moved next by reading the control command (i.e., the G-code). Because the control command usually includes a moving speed, the processor is able to calculate locations that the first print head 10 will pass in the next 10 seconds. A similar method may be applied to the second print head 12, and details regarding the same are not repeated hereinafter.

Alternatively, the processor may also determine whether the first bracket 10a is going to collide with the second bracket 12a when the first print head 10 and the second print head 12 output a predetermined discharge amount (e.g., 10 cm) in the future according to the first control command and the second control command.

When the first bracket 10a is not going to collide with the second bracket 12a, the processor executes the first control command so that the first print head 10 performs the printing operation according to the first control command and executes the second control command so that the second print head 12 performs the printing operation according to the second control command (step S205). It should be noted that, in this embodiment, the printing operation performed by the first print head 10 and the second print head 12 in step S205 is to print the sliced objects on the same layer in the direction Z at the same time.

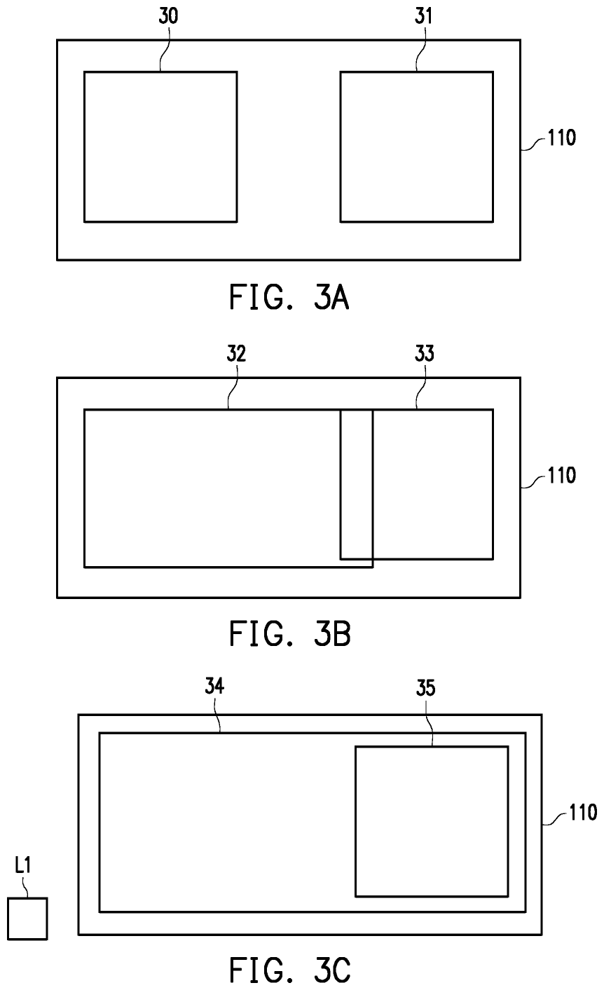

For instance, FIG. 3A to FIG. 3B are schematic diagrams illustrating moving areas of the first print head and the second print head in an embodiment of the invention.

Referring to FIG. 3A, it is assumed that a moving range of the first print head 10 is a moving area 30 and a moving range of the second print head 12 is a moving area 31. In the example of FIG. 3A, because the first bracket 10a of the first print head 10 is not going to collide with the second bracket 12a of the second print head 12, the processor may simultaneously execute the first control command and the second control command so that the first print head 10 performs the printing operation within the moving area 30 according to the first control command and the second print head 12 performs the printing operation within the moving area 31 according to the second control command.

Referring to FIG. 2 again, when the first bracket 10a is going to collide with the second bracket 12a, the processor only executes one of the first control command and the second control command, and suspends execution of the other control command. Here, it is assumed that a first printing progress (e.g., degree of completion) of the first print head 10 for printing a sliced object currently needs to be printed by the first print head 10 is greater than a second printing progress (e.g., degree of completion) of the second print head 12 for printing a sliced object currently needs to be printed by second first print head 12. The processor suspends execution of the first control command to stop the printing operation performed by the first print head 10, and executes only the second control command so that the second print head 12 performs the printing operation according to the second control command (step S207). That is to say, in this embodiment, the processor suspends the printing operation of the print head with the higher printing progress, and preferentially performs the printing operation of the print head with the lower printing progress.

For instance, referring to FIG. 3B, it is assumed that the moving range of the first print head 10 is a moving area 32 and the moving range of the second print head 12 is a moving area 33. In the example of FIG. 3B, it is assumed that a first printing progress (e.g., degree of completion) of the first print head 10 for printing a sliced object currently needs to be printed by the first print head 10 is greater than a second printing progress (e.g., degree of completion) of the second print head 12 for printing a sliced object currently needs to be printed by second first print head 12. Because the first bracket 10a of the first print head 10 is going to collide with the second bracket 12a of the second print head 12 in FIG. 3B, the processor suspends execution of the first control command to stop the printing operation performed by the first print head 10, and executes only the second control command head so that the second print head 12 performs the printing operation according to the second control command.

Referring to FIG. 3C, in another example, it is assumed that the moving range of the first print head 10 is a moving area 34 and the moving range of the second print head 12 is a moving area 35. In the example of FIG. 3C, it is assumed that a first printing progress (e.g., degree of completion) of the first print head 10 for printing a sliced object currently needs to be printed by the first print head 10 is greater than a second printing progress (e.g., degree of completion) of the second print head 12 for printing a sliced object currently needs to be printed by second first print head 12. Because the first bracket 10a of the first print head 10 is going to collide with the second bracket 12a of the second print head 12 in FIG. 3C, the processor suspends execution of the first control command to stop the printing operation performed by the first print head 10, and executes only the second control command head so that the second print head 12 performs the printing operation according to the second control command Particularly, in the example of FIG. 3C, since the range of the moving area 34 includes the moving area 35, the second print head 12 may still collide with the first print head 10 during the movement. Therefore, in this example, the processor controls the first print head 10 to move to a location LI (a.k.a. a first location) which is not in the printing area (e.g., outside the printing platform) so as to prevent the first bracket 10a from colliding with the second bracket 12a during the printing process of the second print head 12.

Referring to FIG. 2 again, after the second control command is executed, the processor selects a control command to be executed (a.k.a. a third control command) from the aforesaid second-type control commands, and determines whether the first bracket 10a is going to collide with the second bracket 12a when the first control command and the third control command are executed simultaneously (step S209). The method for determining whether the collision will occur has been described above, and is thus not repeated hereinafter.

When determining that the first bracket 10a is not going to collide with the second bracket 12a according to the first control command and the third control command, the processor simultaneously executes the first control command and the second control command so that the first print head performs the printing operation according to the first control command and the second print head performs the printing operation according to the third control command (step S211).

However, when determining that the first bracket 10a is going to collide with the second bracket 12a according to the first control command and the third control command, the processor selects a control command (a.k.a. a fourth control command) from the first control command and the third control command and executes the selected control command (step S213). Here, a printing progress of an object printed by a print head corresponding to the fourth control command is the lowest. That is to say, as similar to step S207 described above, the processor suspends the printing operation of the print head with the higher printing progress, and preferentially performs the printing operation of the print head with the lower printing progress.

In particular, after a sliced object of one specific layer in the direction Z is printed, the processor moves the first print head 10 and the second print head 12 to print another sliced object in the direction Z. By completing the printing of the sliced objects of each layer, printing of the complete three-dimensional objects may be completed step by step.

In addition, in one embodiment, the printing may be performed in an asynchronous manner. For example, when printing the sliced object of one specific layer, the processor may first execute the control command of the first print head 10 to print a part that the first print head 10 is responsible for before executing the control command of the second print head 12 to print a part that the second print head 12 is responsible for. Alternatively, the processor may also first execute the control command of the second print head 12 to print the part that the that the second print head 12 is responsible for before executing the control command of the first print head 10 to print the part that the first print head 10 is responsible for. The processor 10 continues to print the sliced object of another layer only after the sliced object of that specific object is printed.

Further, in an embodiment, it is assumed that the first print head 10 is configured to print a first object and the second print head 12 is configured to print a second object. When printing the sliced object of one specific layer, the processor may simultaneously execute the control command of the first print head 10 to print a sliced object of the first object and execute the control commands of the second print head 12 to print the sliced object of the second object. The processor 10 continues to print the sliced object of another layer only after the sliced object of that specific object is printed.

In summary, the apparatus and the method for the three-dimensional printing may allow the three-dimensional printing apparatus having multiple print heads to prevent the print heads from collision and effectively improve the printing efficiency for the print heads.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for three-dimensional printing, adapted to a three-dimensional printing apparatus having a first print head and a second print head, wherein the first print head is slidably disposed on a first bracket so that the first print head moves along a first axis direction, the first bracket is slidably disposed on a first guiding bracket so that the first bracket moves along a second axis direction, the second print head is slidably disposed on a second bracket so that the second print head moves along the first axis direction, the second bracket is slidably disposed on a second guiding bracket so that the second bracket moves along the second axis direction, and the method comprises:
executing a plurality of control commands to control the first print head and the second print head to move and perform a printing operation, wherein the step of performing the printing operation comprises:
determining whether the first bracket is going to collide with the second bracket when a first control command corresponding to the first print head among the plurality of control commands and a second control command corresponding to the second print head among the plurality of control commands are executed simultaneously,
when the first bracket is going to collide with the second bracket, suspending execution of the first control command to stop the printing operation performed by the first print head, and executing the second control command so that the second print head performs the printing operation according to the second control command.

2. The method for three-dimensional printing according to claim 1, further comprising:
when the first bracket is not going to collide with the second bracket, executing the first control command so that the first print head performs the printing operation according to the first control command and executing the second control command so that the second print head performs the printing operation according to the second control command.

3. The method for three-dimensional printing according to claim 1, further comprising:
after executing the second control command, executing the first control command so that the first print head performs the printing operation according to the first control command.

4. The method for three-dimensional printing according to claim 3, wherein before executing the first control command, the method further comprises:
determining whether the first bracket is going to collide with the second bracket when the first control command and a third control command corresponding to the second print head among the plurality of control commands are executed simultaneously.

5. The method for three-dimensional printing according to claim 4, further comprising:
when determining that the first bracket is not going to collide with the second bracket according to the first control command and the third control command, executing the first control command so that the first print head performs the printing operation according to the first control command and executing the third control command so that the second print head performs the printing operation according to the third control command.

6. The method for three-dimensional printing according to claim 5, further comprising:
when determining that the first bracket is going to collide with the second bracket according to the first control command and the third control command, selecting a fourth control command from the first control command and the third control command and executing the fourth control command, wherein a printing progress of an object printed by a print head corresponding to the fourth control command is the lowest.

7. The method for three-dimensional printing according to claim 1, wherein a first printing progress corresponding to an object printed by the first print head is greater than a second printing progress corresponding to an object printed by the second print head.

8. The method for three-dimensional printing according to claim 1, wherein the step of determining whether the first bracket is going to collide with the second bracket comprises:
determining whether the first bracket is going to collide with the second bracket within a future time interval according to the first control command and the second control command.

9. The method for three-dimensional printing according to claim 1, wherein the step of determining whether the first bracket is going to collide with the second bracket comprises:
determining whether the first bracket is going to collide with the second bracket when the first print head and the second print head output a predetermined discharge amount according to the first control command and the second control command.

10. The method for three-dimensional printing according to claim 1, wherein the step of suspending execution of the first control command comprises:
controlling the first print head to move to a first location to prevent the first bracket from colliding with the second bracket.

11. The method for three-dimensional printing according to claim 1, wherein the first guiding bracket is slidably disposed on a third guiding bracket so that the first guiding bracket moves along a third axis direction and the second guiding bracket is slidably disposed on a fourth guiding bracket so that the second guiding bracket moves along the third axis direction.

12. The method for three-dimensional printing according to claim 11, further comprising:
after a sliced object in the third axis direction is printed, moving the first print head and the second print head to print another sliced object in the third axis direction.

13. The method for three-dimensional printing according to claim 1, wherein the first print head and the second print head are configured to print different parts of a same object.

14. The method for three-dimensional printing according to claim 1, wherein the first print head and the second print head are configured to print different objects, respectively.
